(19) United States
(12) Patent Application Publication
(10) Pub. No.: US 2026/0042697 A1
(43) Pub. Date: Feb. 12, 2026

(54) GLASS AND STRENGTHENED GLASS

(71) Applicant: CORNING INCORPORATED, CORNING, NY (US)

(72) Inventors: Lawrence Vincent Daniel Gammond, Painted Post, NY (US); Timothy Michael Gross, Painted Post, NY (US); Jingshi Wu, Painted Post, NY (US)

(21) Appl. No.: 19/169,570

(22) Filed: Apr. 3, 2025

Related U.S. Application Data
(60) Provisional application No. 63/681,448, filed on Aug. 9, 2024.

(30) Foreign Application Priority Data
Nov. 14, 2024 (GB) 2416788.4

(51) Int. Cl. C03C 3/068

(52) U.S. Cl. CPC C03C 3/068

(57) ABSTRACT

A glass includes silica, alumina, boria, and yttria. The glass may have high fracture toughness, often greater than 1 MPa·m^{1/2}, as well as high Vickers hardness, on the order of 800 kgf/mm² or greater. Furthermore, Applicants find that, due to surprisingly large high-temperature coefficient of thermal expansion (e.g., over 35 ppm/° C. at about 875° C.) and high elastic modulus (e.g., >120 GPa) the glass may be particularly suitable for thermal tempering, which may strengthen a corresponding article comprising the glass.

### CROSS-REFERENCE TO RELATED APPLICATIONS

The present application claims the priority benefit of U.S. Application No. 63/681,448, filed on Aug. 9, 2024 and the priority benefit of Great Britain Patent Application No. 2416788.4, filed on Nov. 14, 2024, which also claims the priority benefit of U.S. Application No. 63/681,448, filed on Aug. 9, 2024, each of which is hereby incorporated by reference herein in its entirety.

### BACKGROUND

Aspects of the present disclosure relate to glass, as may be used with housings or covers for electronic devices or otherwise.

Glass, such as sheets of glass, may provide a protective covering for displays of electronic devices, such as cellular phones and laptop computers, or solar cells. Other glasses may be used for housings of electronic components or for substrates that may support circuitry. Still other glasses may be useful for windows, such as windshields, sunroofs, and panes within architecture. The glass may be formed as sheets via a fusion forming process, so-called float method, rolling, or otherwise. Sheets of the glass may then be cut to shape and integrated with a frame and/or electronics for example. Some such glass may be naturally strong and/or may be further strengthened.

While glasses available today may serve some of these needs, a need exists for alternative glasses that may be naturally stronger, require less if any strengthening, that may be made stronger than glasses available today, that may require fewer resources or less energy to make than alternatives, and/or that may be positioned in close proximity to electronics without excessively leaching into or otherwise harming the electronics.

### SUMMARY

Applicants discovered new glasses comprising silica, alumina, boria, and yttria that solve such needs. The glasses have high fracture toughness, often greater than 1 MPa·m^{1/2}, as well as high Vicker's hardness, on the order of 800 kgf/mm² or greater. Furthermore, Applicants find that, due to surprisingly high high-temperature coefficients of thermal expansion (e.g., over 35 ppm/° C. at about 875° C.) and high elastic moduli (i.e. stiffness; e.g., >120 GPa), these glasses are particularly suited to be strengthened via thermal tempering. With that said, Applicants contemplate that lithium containing variations of such glasses may be suitable for ion-exchange strengthening, such as in a molten salt bath at temperatures over 500° C. for example.

The combinations of boria and yttria disclosed herein may be particularly surprising in aluminosilicate glasses disclosed herein because of physical properties of the resulting glasses, such as elastic moduli greater than 120 GPa, roughly twice that of other borosilicate glasses or soda lime glass. Typically boron may be expected to lower such properties because trigonal boron sites in a glass network have low dissociation energy. However while boron in glasses disclosed herein may be mostly situated in trigonal boron sites, the glasses surprisingly retain particularly high elastic moduli and other physical properties disclosed herein. This is unexpected. Further, Applicants find that the boron improves manufacturability of such glasses, by raising the liquidus viscosity of high yttria-containing glasses and lowering the liquidus temperature, facilitating use of rollers for forming sheets of the glasses.

Beyond silica, alumina, boria, and yttria, Applicants discovered other constituents may be added to the glasses to enhance properties or provide other capabilities, with the glasses still retaining particularly high elastic moduli and other physical properties disclosed herein. For example, Applicants find that alkaline earth oxides, such as magnesia, may be added in place of silica or alumina for example, to further augment the high elastic modulus. Also, alkali metal oxides may be added, such as lithia at amounts over 5 mol %, while the glasses still retain particularly high elastic moduli and other physical properties disclosed herein. Applicants believe such glasses can be ion-exchanged to provide additional strength to the glasses. Because of high strain points, Applicants contemplate using higher temperature salt baths (e.g., >500° C.) and sulfur-containing salts (e.g., potassium sulfate) to facilitate the chemical strengthening process.

While glasses disclosed herein may appear to have a low CTE, roughly less than 10 ppm/° C. (or units of ×10⁻⁶ per degree K), such as when measured at temperatures below 600° C., Applicants discovered the glasses have a surprisingly high high-temperature coefficient of thermal (“CTE”) expansion (e.g., at 850° C.). While one might expect the high-temperature CTE of a glass to increase relative to the CTE at lower temperatures, glasses disclosed herein have CTEs that increase by over four times. As a result of this finding in combination with the high elastic moduli of the glass, Applicants believe glasses disclosed herein are particularly well-suited for thermal tempering, where the glass is heated above transition temperature, and rapidly cool such that the exterior is ‘frozen’ in an expanded state or high fictive temperature, while interior glass more slowly cools and pulls the exterior into compression, balanced by tension in the interior.

Additional features and advantages are set forth in the detailed description that follows, and in part will be readily apparent to those skilled in the art from the description or recognized by practicing the technology as described in the written description and claims hereof, as well as the appended drawings. It is to be understood that both the foregoing general description and the following detailed description are merely exemplary and are intended to provide an overview or framework to understand the nature and character of the claims.

### BRIEF DESCRIPTION OF THE FIGURE

The accompanying figures are included to provide a further understanding and are incorporated in and constitute a part of this specification. The drawing/images of the figures illustrate one or more aspects of the present disclosure, and/or together with the detailed description explain principles and operations of the various aspects. As such, the disclosure will become more fully understood from the following detailed description, taken in conjunction with the accompanying figures, in which:

FIG. 1 is a perspective view of a glass article overlaying a cuboid space according to an aspect of the present disclosure.

FIG. 2A is a top view of a glass article according to an aspect of the present disclosure.

FIGS. 2B and 2C are top views of cuboid pieces of glass cut from the glass article of FIG. 2A.

FIG. 3A is a top view of a glass article according to another aspect of the present disclosure.

FIGS. 3B and 3C are top views of cuboid pieces of glass cut from the glass article of FIG. 3A.

FIG. 4 is a top view of a glass article according to yet another aspect of the present disclosure.

FIG. 5 is a plot of coefficients of thermal expansion versus temperature for the glasses of FIGS. 2A-2C and 3A-3C.

FIG. 6 is a conceptual view in side, cross-section of a tempered glass article according to an aspect of the present disclosure.

### DETAILED DESCRIPTION

Before turning to the following detailed description and figures, which illustrate aspects of the present disclosure in detail, it should be understood that the present inventive technology is not limited to the details or methodology set forth in the detailed description or illustrated in the figures. For example, as will be understood by those of ordinary skill in the art, features and attributes associated with an aspect shown in the figures or described in the text relating to an aspect may be applied to another aspect described elsewhere in the text.

Applicants discovered new glasses with useful properties, such as fracture toughness, stiffness, and hardness, which are beneficial in protective cover-glass uses as well as other applications relying upon glass.

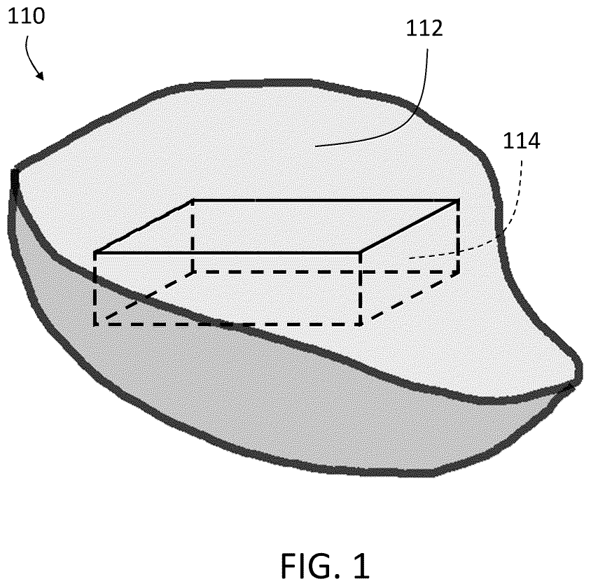

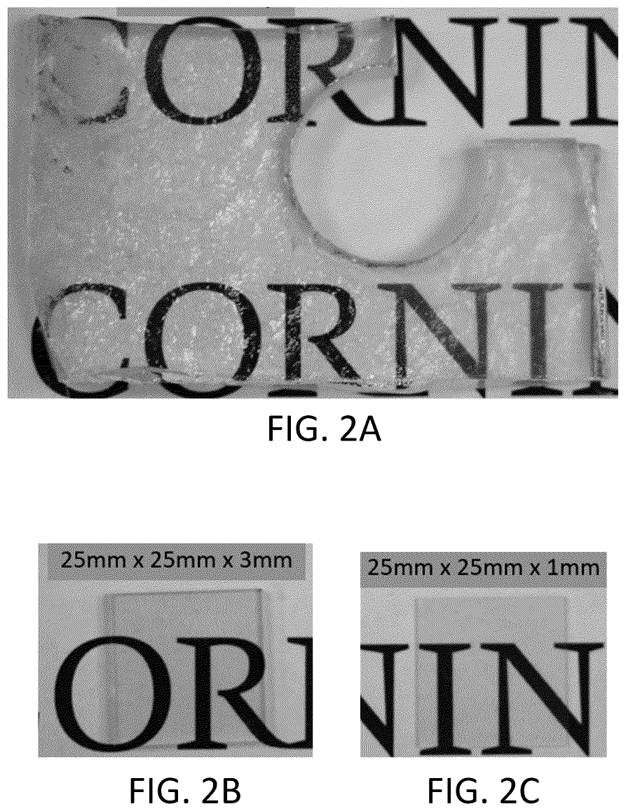

Referring to FIG. 1, an article, such as glass article 110, may comprise a body 112 of glass that may fully overlay a box- or cuboid-space 114 within the body 112 of glass. Put another way, geometry of the article 110 is such that the cuboid-space 114 fits within the body 112 of glass of the article 110. The cuboid-space 114 includes rectangular sides having dimensions, such as 25 millimeters (mm) by 25 mm by 3 mm thickness (see e.g., FIG. 2B) or by 1 mm thickness (see e.g., FIG. 2C), with a volume greater than or equal to 1 mm³, such as greater than 2 mm³, 5 mm³, 100 mm³. According to an aspect, volume of the cuboid-space 114 is less than the capacity of a commercial glass melter, such as less than 275 cubic decameters (dam³), such as less than 200 dam³. According to an aspect, the body 112 is a contiguous volume of the glass in an amorphous state, without a homogenously-distributed crystal phase therein, but which may include inclusions common for glass, such as small un-melted batch particles (e.g., <50 microns particle size), blisters, cord.

According to an aspect, the article 110 is sized such that the body 112 of contiguous glass fully overlays a spherical-space (not shown; cf. cuboid-space 114), such as a spherical space with a diameter greater than 50 microns (i.e. micrometers, abbreviated μm), such as greater than 100 microns, such as greater than 0.5 mm, and/or less than 10 dam, such as less than 5 dam. In still other aspects, the article 110 is sized such that the body 112 of contiguous glass fully overlays a tube-space (not shown; e.g., pipe; cf. cuboid-space 114), such as a tube-space with an outside diameter greater than 1 mm and an interior diameter of greater than 1 micron less than the outside diameter, or a cylindrical space (e.g., fiber or rod) having such a diameter. According to an aspect, the body 112 overlaying the tube- or cylindrical space, is such that the tube- or cylindrical space has a volume greater than or equal to 1 mm³, such as greater than 2 mm³, 5 mm³, 100 mm³, and less than 275 dam³, such as less than 200 dam³.

Glasses herein may be characterized in terms of concentrations of constituent component oxides, provided in representative oxide form (e.g., SiO₂ “silica,” Al₂O₃ “alumina,” Y₂O₃“yttria,” B₂O₃“boria,” Li₂O “lithia,” MgO “magnesia”) and are specified in mole percent (mol %) on an oxide basis, unless otherwise specified (e.g., when specified by weight or mass percent, or by volume percent).

According to an aspect, silica (SiO₂) may be a glass former in glasses herein and may function to stabilize a network structure of the glass. Concentration of silica may be sufficiently high to enhance chemical durability of the glass and, in particular, resistance of the glass to degradation upon exposure to acidic solutions, basic solutions, and water. Amounts of silica may be limited to control the melting point of the glass, as the melting point of pure silica or high-silica glasses may be particularly high. Thus, limiting concentration of silica may aid in improving meltability and formability of the glass. Further, Applicants find that some silica can be removed and replaced with other constituents, in glasses disclosed herein, to augment physical properties of resulting glasses, such as increasing elastic modulus by adding alkaline earth metal oxides in addition to silica, alumina, boria, and yttria.

As such, according to an aspect, glasses disclosed herein include a positive or non-zero amount of silica, such as silica present in the glass above tramp levels, such as greater than 0.01 mol %, greater than 0.02 mol %, and/or greater than 0.05 mol %. According to an aspect, the silica is in an amount greater than 0 mol % and less than or equal to 70 mol %, such as greater than or equal to 0.1 mol %, 10 mol %, 12 mol %, 15 mol %, 20 mol %, 25 mol %, and/or less than or equal to 68.7 mol %, such as less than or equal to 50 mol %, 45 mol %, 40 mol %, 35 mol %, or any combination of such bounds. For example, according to an aspect, the amount of silica is greater than or equal to 12 mol % and less than or equal to 45 mol %, such as greater than or equal to 12 mol % and less than or equal to 28 mol %, such as greater than or equal to 15 mol % and less than or equal to 28 mol %, such as greater than 20 mol %, and less than or equal to 28 mol % in some examples.

According to an aspect, glasses disclosed herein include alumina (aluminum oxide, Al₂O₃), which may also stabilize the glass network like silica, and may additionally provide improved mechanical properties and chemical durability to the glass. Amounts of Al₂O₃ may also be tailored to control viscosity of the glass. For example, alumina may be included such that the resultant glass has desired fracture toughness (e.g., greater than or equal to 0.95 MPa·m^{1/2}). However, if amounts of alumina are too high, formability of the glass melt may decrease, such as where the liquidus viscosity is too low or the glass devitrifies too easily.

As such, according to an aspect, glasses disclosed herein include a positive or non-zero amount of alumina, such as alumina present in the glass above tramp levels, such as greater than 0.01 mol %, greater than 0.02 mol %, and/or greater than 0.05 mol %. According to an aspect, the amount of alumina is greater than or equal 5 mol %, such as greater than or equal to 11.2 mol %, such as greater than equal to 15 mol %, and/or less than or equal to 80 mol %, such as less than or equal to 50 mol %, such as less than or equal to 45 mol %, such as less than or equal to 30 mol %, such as less than or equal to 25 mol %, or any combination of such bounds. For example, according to an aspect, the amount of alumina is greater than 11.12 mol % and less than 79.8 mol %, such as greater than 12 mol % and less than 45 mol %, such as greater than 15 mol % and less than 30 mol % in some examples.

According to an aspect, glasses disclosed herein may include yttria (Y₂O₃), which Applicants believe increases Young's modulus (i.e. elastic modulus) of the glass because yttria has a high dissociation energy and facilitates a densely packed atomic arrangement for the glasses. Applicants note that alumina likewise has a high dissociation energy, and thus pairs well with yttria to achieve strong glasses as disclosed herein. One might expect that if the amount of yttria is too high, the glass may devitrify or crystallize upon cooling, and that may happen to an extent, as disclosed below, but Applicants have made glasses as disclosed herein with over 35 mol % yttria.

According to an aspect, glasses disclosed herein include a positive or non-zero amount of yttria, such as yttria present in the glass above tramp levels, such as greater than 0.01 mol %, greater than 0.02 mol %, and/or greater than 0.05 mol %. According to an aspect, the yttria is in an amount of greater than or equal to 8 mol % and less than or equal to 90 mol %; such as greater than or equal to 10 mol %, 12 mol %, 15 mol %, 18 mol %, 20 mol %, 20.03 mol %, 20.5 mol %, 21 mol %, 22 mol %, 24 mol %, 25 mol %, 28 mol %, and/or less than or equal to 50 mol %, such as less than 45 mol %, such as less than 40 mol %, or any combination of such bounds. For example, according to an aspect, the amount of yttria is greater than or equal to 14 mol % and less than or equal to 45 mol %, such as greater than or equal to 21 mol % and less than or equal to 45 mol %, such as greater than or equal to 24 mol % and less than or equal to 40 mol %.

Applicants were surprised to discover that the amount of yttria in the glass could exceed 20.03 mol %, as described above, and the glass would remain amorphous without relying upon unusual manufacturing methods, such as levitation and laser-heating. To make such glasses using melt and quench techniques, Applicants discovered that boria may be used to improve meltability, such as by lowering liquidus temperature, such as below 1400° C., such as below 1350° C., such as below 1300° C., and in some instances below 1200° C. And surprisingly, the glasses with the boria as disclosed herein retained high moduli of elasticity, such as values over 110 GPa, such as over 120 GPa, such as over 130 GPa, and even over 140 GPa in some glasses.

One might also expect inclusion of boria to reduce the modulus of elasticity of such glasses below 100 GPa, such as on the order of 60-80 GPa, comparable to soda-lime and other borosilicate glasses, because such glasses form trigonal boron sites, which have particularly low dissociation energy. Boron in glasses disclosed herein may too partially or even mostly reside in trigonal sites, as shown by magic-angle spinning (MAS) nuclear magnetic resonance (NMR), such as greater than 50% of the boron of the glass residing in trigonal sites, such as greater than 60%, greater than 70%, and sometimes even greater than 80%, such as 88% for 20(Y₂O₃)-20(Al₂O₃)-30(B₂O₃)-30(SiO₂) glass, and correspondingly less than 25% at tetrahedral sites, such as less than 15% of the boron. However, surprisingly, boria even at high molar percentages as disclosed herein, did not lower the modulus of glasses disclosed herein below 120 GPa in many instances. When combined with yttria, the boria was still able to form robust glasses of dense networks, as disclosed herein. The same reference glass showed 62% of the aluminum of the glass at tetrahedral sites, 30% at pentahedral sites, and 8% at octahedral sites. Applicants contemplate that aluminum, especially at greater than 30% pentahedral and/or greater than 8% octahedral sites may allow glasses disclosed here to achieve high packing density of atoms in the respective network.

According to an aspect, glasses disclosed herein include a positive or non-zero amount of boria, such as boria present in the glass above tramp levels, such as greater than 0.01 mol %, greater than 0.02 mol %, and/or greater than 0.05 mol %. According to an aspect, the amount of boria in the glasses is greater than or equal to 5 mol %, such as greater than or equal to 10 mol %, 12 mol %, 15 mol %, 18 mol %, 20 mol %, or even greater than or equal to 25 mol %, and/or less than or equal to 68.7 mol %, such as less than or equal to 50 mol %, 45 mol %, 42 mol %, 40 mol %. For example, according to an aspect, the boria is in an amount greater than 0 mol % and less than or equal to 68 mol %, such as greater than or equal to 8 mol %, such as greater than or equal to 12 mol %, and/or less than or equal to 45 mol %.

Glasses of Table 1 and others disclosed herein may be free or largely free of alkali metal oxides, such as the glasses having less than 1 mol %, less than 0.5 mol %, less than 0.2 mol %, less than 0.1 mol % of alkali metal oxides (in sum). Some glasses disclosed herein may have a sum of lithia (Li₂O), sodium oxide (Na₂O), and potassium oxide (K₂O) less than 1 mol %, less than 0.5 mol %, less than 0.2 mol %, less than 0.1 mol %. Such glasses may be naturally strong—stiff and tough, and may not need chemical tempering to serve as a protective cover, or other purposes, such as windows, or substrates for circuitry. For example, some circuitry (such as light-emitting diode arrays; photovoltaic cells) may benefit from high-temperature processing (e.g., >700° C.), or other processing at which glasses containing alkali metals may leach such metals from the glasses, potentially impacting the circuitry. Accordingly, glasses herein, which are tough and strong without chemical tempering, may be particularly useful.

That being said, alkali metal oxides, such as lithia (Li₂O), soda (Na₂O), and potassium oxide (K₂O), may be added to glasses disclosed herein. Such constituents may facilitate ion-exchange chemical tempering of the glasses, where the glasses are soaked in molten salt of larger-ion alkali metals, such as potassium nitrate and/or potassium sulfate, and the larger-ions (e.g. K⁺) are swapped for smaller ions in the glass, producing compression at surfaces of the glass. As with boria, one might expect the alkali metal oxides to weaken mechanical attributes of the resulting glass, such as lowering the modulus of elasticity, and Applicants found some such effect, but glasses disclosed herein, even with alkali metal oxides were still particularly dense, stiff, tough, hard, etc., when compared to other glasses, even without chemical tempering of the presently disclosed glasses. Further, tolerance for alkali metal oxides (e.g., greater than 0.01 mol %, such as greater than 0.02 mol %, but less than 5 mol %, such as less than 2 mol %), such as some amounts of sodium oxide or potassium oxide, may allow for use of lower-grade raw materials in the glass batch, which may be less energy-intensive to mine and process, and therefore better for the environment.

According to an aspect, glasses disclosed herein include a positive or non-zero amount of alkali metal oxides, such as a sum of amounts of lithia, sodium oxide, and potassium oxide, such as alkali metal oxides present in the glass above tramp levels, and/or greater than 0.01 mol %, such as greater than 0.02 mol %. According to an aspect, a sum of the amount of alkali metal oxides in the glasses is greater than or equal to 5 mol %, such as greater than or equal to 10 mol %, 12 mol %, 15 mol %, 18 mol %, 20 mol %, and/or less than or equal to 68 mol %, such as less than or equal to 40 mol %, 35 mol %, 32 mol %, 30 mol %, 25 mol %. For example, according to an aspect, the amount of alkali metal oxides is greater than or equal to 5 mol % and less than or equal to 30 mol %, such as greater than or equal to 10 mol %, such as greater than or equal to 12 mol %, and/or less than or equal to 25 mol %.

According to an aspect, glasses disclosed herein include a positive or non-zero amount of lithia (Li₂O), such as lithia present in the glass above tramp levels, such as greater than 0.02 mol %. According to an aspect, the amount of lithia in the glasses is greater than or equal to 5 mol %, such as greater than or equal to 10 mol %, 12 mol %, 15 mol %, 18 mol %, 20 mol %, and/or less than or equal to 68 mol %, such as less than or equal to 40 mol %, 35 mol %, 32 mol %, 30 mol %, 25 mol %. For example, according to an aspect, the amount of lithia is greater than or equal to 5 mol % and less than or equal to 30 mol %, such as greater than or equal to 10 mol %, such as greater than or equal to 12 mol %, and/or less than or equal to 25 mol %. Such amounts of lithia may facilitate ion-exchange in a salt bath of sodium- and potassium-containing salts, such as sodium sulfate, sodium nitrate, potassium sulfate, and/or potassium nitrate.

According to an aspect, glasses disclosed herein include a positive or non-zero amount of sodium oxide (Na₂O), such as sodium oxide present in the glass above tramp levels, such as greater than 0.02 mol %. According to an aspect, the amount of sodium oxide in the glasses is greater than or equal to 5 mol %, such as greater than or equal to 10 mol %, 12 mol %, 15 mol %, 18 mol %, 20 mol %, and/or less than or equal to 68 mol %, such as less than or equal to 40 mol %, 35 mol %, 32 mol %, 30 mol %, 25 mol %. For example, according to an aspect, the amount of sodium oxide is greater than or equal to 5 mol % and less than or equal to 30 mol %, such as greater than or equal to 10 mol %, such as greater than or equal to 12 mol %, and/or less than or equal to 25 mol %. Such amounts of sodium oxide may facilitate ion-exchange in a salt bath of potassium-containing salts, such as potassium sulfate and/or potassium nitrate.

Alkaline earth metal oxides, such as magnesia (MgO) or quicklime (CaO), may be added to glasses disclosed herein. Such constituents may aid in strengthening the glasses, such as by raising an elastic modulus, increasing toughness, increasing hardness, etc., when used in conjunction with yttria, boron, alumina, and silica as disclosed herein. Too much alkaline earth metal oxides may lead to devitrification or challenges with melting due to raising the melting temperatures of the glasses. Also, such glasses with too much alkaline earth metal oxides may have challenges with low liquidus viscosity and forming.

According to an aspect, glasses disclosed herein include a positive or non-zero amount of alkaline earth metal oxides, such as a sum of amounts of magnesia, quicklime, strontia (SrO), or other alkaline earth metal oxides; such as alkaline earth metals oxides present in the glass above tramp levels, and/or greater than 0.01 mol %, such as greater than 0.02 mol %. According to an aspect, a sum of the amount of alkaline earth metal oxides in the glasses is greater than or equal to 5 mol %, such as greater than or equal to 8 mol %, 10 mol %, 12 mol %, 15 mol %, 18 mol %, 20 mol %, and/or less than or equal to 68 mol %, such as less than or equal to 50 mol %, 45 mol %, 38 mol %, 30 mol %, 25 mol %. For example, according to an aspect, the amount of alkali metal oxides is greater than or equal to 5 mol % and less than or equal to 45 mol %, such as greater than or equal to 10 mol %, such as greater than or equal to 12 mol %, and/or less than or equal to 35 mol %.

According to an aspect, glasses disclosed herein include a positive or non-zero amount of magnesia, such as magnesia (MgO) present in the glass above tramp levels, and/or greater than 0.01 mol %, such as greater than 0.02 mol %. According to an aspect, the amount of magnesia in the glasses is greater than or equal to 5 mol %, such as greater than or equal to 8 mol %, 10 mol %, 12 mol %, 15 mol %, 18 mol %, 20 mol %, and/or less than or equal to 68 mol %, such as less than or equal to 40 mol %, 35 mol %, 32 mol %, 30 mol %, 25 mol %. For example, according to an aspect, the amount of magnesia is greater than or equal to 5 mol % and less than or equal to 45 mol %, such as greater than or equal to 10 mol %, such as greater than or equal to 12 mol %, and/or less than or equal to 35 mol %.

According to an aspect, glasses disclosed herein include a positive or non-zero amount of quicklime (CaO), such as quicklime present in the glass above tramp levels, and/or greater than 0.01 mol %, such as greater than 0.02 mol %. According to an aspect, the amount of quicklime in the glasses is greater than or equal to 5 mol %, such as greater than or equal to 8 mol %, 10 mol %, 12 mol %, 15 mol %, 18 mol %, 20 mol %, and/or less than or equal to 68 mol %, such as less than or equal to 40 mol %, 35 mol %, 32 mol %, 30 mol %, 25 mol %. For example, according to an aspect, the amount of quicklime is greater than or equal to 5 mol % and less than or equal to 40 mol %, such as greater than or equal to 10 mol %, such as greater than or equal to 12 mol %, and/or less than or equal to 35 mol %.

Applicants contemplate that both magnesia and quicklime may be used together in glasses as disclosed herein, such as where a sum of amounts of magnesia and quicklime is present in the glass above tramp levels, and/or greater than 0.01 mol %, such as greater than 0.02 mol %. According to an aspect, the sum of amounts of magnesia and quicklime in the glasses is greater than or equal to 5 mol %, such as greater than or equal to 10 mol %, 12 mol %, 15 mol %, 18 mol %, 20 mol %, and/or less than or equal to 68 mol %, such as less than or equal to 40 mol %, 35 mol %, 32 mol %, 30 mol %, 25 mol %. For example, according to an aspect, the sum of amounts of magnesia and quicklime is greater than or equal to 5 mol % and less than or equal to 45 mol %, such as greater than or equal to 10 mol %, such as greater than or equal to 12 mol %, and/or less than or equal to 35 mol %.

According to an aspect of the present disclosure, lanthana (La₂O₃) and/or titania (TiO₂) may also be used to supplement and/or complement the yttria, increasing mechanical properties of the corresponding glasses in combination with the boria, alumina, and silica disclosed herein. Too much of either constituent may undermine formability. Too much titania may turn the glasses white or hazy.

According to an aspect, glasses disclosed herein include a positive or non-zero amount of lanthana, such as lanthana present in the glass above tramp levels, such as greater than 0.02 mol %. According to an aspect, the amount of lanthana in the glasses is greater than or equal to 2 mol %, such as greater than or equal to 4 mol %, 5 mol %, 8 mol %, 10 mol %, 12 mol %, and/or less than or equal to 35 mol %, such as less than or equal to 25 mol %. For example, according to an aspect, the amount of lanthana is greater than or equal to 2 mol % and less than or equal to 35 mol %, such as greater than or equal to 4 mol %, such as greater than or equal to 5 mol %, and/or less than or equal to 25 mol %.

According to an aspect, glasses disclosed herein include a positive or non-zero amount of titania, such as titania present in the glass above tramp levels, such as greater than 0.02 mol %. According to an aspect, the amount of titania in the glasses is greater than or equal to 2 mol %, such as greater than or equal to 4 mol %, 5 mol %, 8 mol %, 10 mol %, 12 mol %, and/or less than or equal to 25 mol %, such as less than or equal to 20 mol %, 18 mol %. For example, according to an aspect, the amount of titania is greater than or equal to 2 mol % and less than or equal to 20 mol %, such as greater than or equal to 4 mol %, such as greater than or equal to 5 mol %, and/or less than or equal to 18 mol %.

### Examples

The following Table 1 provides a first group of examples of glasses made and found to have properties disclosed herein. The samples of Table 1 (and Table 2 further below) were roughly 2000-grams in weight. The glasses of Table 1 were all made using melt-quench methods, where raw batch materials were mixed and heated to melt together in a physical container (e.g., platinum crucible, refractory-lined tank), from there the molten glass was formed, such as poured into a mold, with a sample size of about 2000 g and cooled in air, and then annealed.

The examples in Table 1 are provided in terms of mol % as analyzed. Density of the glass compositions may be determined using buoyancy method of ASTM C693-93(2013) in units of grams per cubic centimeter (g/cc). The strain point and annealing point temperatures in Celsius (° C.) of the glasses may be determined using beam bending viscosity (BBV) method of ASTM C598-93(2013). The term “annealing point,” as used herein, refers to the temperature at which the viscosity of the glass composition is 1×10^{13.18} poise and “strain point” refers to the temperature at which the viscosity of the glass composition is 1×10^{14.68} poise. Poisson's ratio, elastic modulus (“Young's modulus”), and shear modulus of the glass may be measured by a resonant ultrasound spectroscopy (RUS) technique of the general type set forth in ASTM E2001-13, titled “Standard Guide for Resonant Ultrasound Spectroscopy for Defect Detection in Both Metallic and Non-metallic Parts.”

TABLE 1

| | Ex. A | Ex. B | Ex. C | Ex. D | Ex. E | Ex. F | Ex. G |
|---|---|---|---|---|---|---|---|
| analyzed (mol %) | | | | | | | |
| SiO₂ | 31.11 | 31.33 | 26.33 | 21.83 | 26.58 | 29.87 | 28.29 |
| Al₂O₃ | 19.26 | 19.26 | 19.29 | 19.49 | 19.38 | 19.74 | 19.53 |
| B₂O₃ | 25.41 | 20.32 | 30.12 | 29.42 | 24.85 | 16.42 | 18.32 |
| Na₂O | 0.05 | 0.05 | 0.05 | 0.05 | 0.06 | | |
| K₂O | 0.01 | 0.01 | 0.01 | 0.01 | 0.01 | | |
| MgO | 0.01 | | 0.02 | | 0.01 | 0.10 | 0.09 |
| CaO | 0.04 | 0.04 | 0.04 | 0.04 | 0.04 | 0.04 | 0.04 |
| Y₂O₃ | 24.08 | 28.95 | 24.12 | 29.10 | 29.03 | 33.83 | 33.73 |
| TiO₂ | | | | | | 0.01 | |
| Fe₂O₃ | 0.01 | 0.01 | 0.01 | 0.01 | 0.01 | 0.01 | 0.01 |
| SO₃ | | | | 0.02 | | | |
| Cl | 0.02 | 0.02 | 0.02 | 0.03 | 0.03 | | |
| Properties | | | | | | | |
| Density (g/cc) | 3.575 | 3.812 | 3.551 | 3.757 | 3.784 | 4.023 | 4.008 |
| BBV-T_strain (° C.) | 727 | 749 | 714 | 719 | 733 | 769 | 761 |
| BBV-T_anneal (° C.) | 762 | 784 | 748 | 753 | 767 | 803 | 795 |
| RUS-Young's (GPa) | 120.8 | 128.1 | 120.0 | 126.4 | 127.4 | 132.9 | 132.4 |
| RUS-Shear (GPa) | 47.1 | 49.8 | 46.8 | 49.1 | 49.5 | 51.8 | 51.6 |
| RUS-Poisson's | 0.283 | 0.287 | 0.283 | 0.288 | 0.287 | 0.283 | 0.282 |

As shown in Table 1, glasses mostly included silica, alumina, boria, and yttria as major constituents of the glasses. The glasses further included amounts of alkaline earth metal oxides (including magnesia and/or quicklime) and alkali metal oxides (including sodium oxide and potassium oxide), as well as titania, ferrous oxide, sulfur trioxide, and chlorine. The sum of alkaline earth metal oxides was greater than 0.01 mol %, such as greater than 0.02 mol %, even greater than 0.05 mol % in many of the examples, and/or less than 2 mol %. Similarly, the sum of alkali metal oxides was greater than 0.01 mol %, such as greater than 0.02 mol %, even greater than 0.05 mol % in many of the examples, and/or less than 2 mol %. Other examples, such as Examples F and G had no alkali metal oxides (or less than 0.005 mol % per alkali metal oxide such that the amount rounded to zero).

Glasses of Table 1 had densities greater than 3.5 g/cc (i.e. grams per cubic centimeter), some greater than 3.75 g/cc, and still some even greater than 4 g/cc, which is particularly dense for glass; but all the glasses in Table 1 were less than 5 g/cc in density. For context, soda-lime glass may have a density of around 2.5 g/cc. The highest density glasses in Table 1 had the most yttria, over 30 mol % yttria, and over 15 mol % but less than 20 mol % boria.

Strain temperatures for glasses of Table 1 were each over 700° C., most over 725° C., some over 750° C.; but all the glasses in Table 1 had less than 800° C. for strain temperature. Similar to density, glasses in Table 1 with the highest strain temperature had the most yttria, over 30 mol % yttria, and over 15 mol % but less than 20 mol % boria. The trend for anneal temperature was similar, but with anneal temperatures about 34° C. greater than strain temperatures for the examples.

Perhaps most interesting for the glasses of Table 1 were the high elastic moduli values (and shear modulus). The glasses of Table 1 each had an elastic modulus of at least 120 GPa, some had elastic moduli greater than 125 GPa, and some even had elastic moduli over 130 GPa; but all the glasses in Table 1 had an elastic modulus below 150 GPa. For context, soda lime glass has roughly half such an elastic modulus, on the order of 70-75 GPa, and those of skill in the art might expect borosilicate glass to have a modulus less than soda lime, such as 60-65 GPa, at least in part due to the boron residing in trigonal boron sites within the glass network, which have low dissociation energy. But the glasses disclosed herein, which include boria, some including significant amounts of boria, have twice such elastic moduli! Put another way, there is not necessarily a tradeoff between including boria for improved meltability, forming, scratch resistance, etc., versus elastic modulus for glasses disclosed herein. Glasses herein are both stiff and include boria.

According to an aspect, at least some (amorphous) glasses of the present disclosure have remarkably high moduli of elasticity, such as exceeding 110 GPa, 120 GPa, 130 GPa, and even exceeding 140 GPa, and/or less than 160 GPa. Elastic modulus (also called Young's modulus) may be measured by resonant ultrasound spectroscopy, Brillouin spectroscopy, tensile test, or otherwise, and corresponds to slope of stress (tensile load over cross-sectional area) versus strain (change in length per unit length) over an elastic region of the stress-strain relationship of the glass, which is approximately until failure for brittle materials such as glasses herein, at standard conditions, such as roughly 200 C, 40% relative humidity, sea level atmospheric pressure, etc.; but unless otherwise specified, such as in the claims, assume elastic modulus is measured by RUS (e.g., ASTM C623-21).

Liquidus temperature refers to the temperature at which crystals first appear as a molten glass cools down from the melting temperature, or the temperature at which crystals fully melt away as temperature is increased from room temperature, and may be measured in accordance with ASTM C829-81 (2015), titled “Standard Practice for Measurement of Liquidus Temperature of Glass by the Gradient Furnace Method.” Although not listed in Table 1, Examples A-E were measured to have liquidus temperatures between 1250° C. and 1350° C., specifically 1255° C., 1310° C., 1275° C., 1370° C., and 1330° C. respectively. Such liquidus temperatures, below 1400° C., may useful for commercial manufacturing of glasses, operating within temperature limits of platinum and furnace refractories.

Fracture toughness (K_{IC}), or resistance of brittle materials such as glass to propagation of cracks under loading, may be measured by the chevron notched short bar (CNSB) method. For example, the chevron notched short bar (CNSB) method is disclosed in Reddy, K. P. R. et al, Fracture Toughness Measurement of Glass and Ceramic Materials Using Chevron-Notched Specimens, J. Am. Ceram. Soc., 71 [6], C-310-C-313 (1988) except that Y*ₘ is calculated using equation 5 of Bubsey, R. T. et al., Closed-Form Expressions for Crack-Mouth Displacement and Stress Intensity Factors for Chevron-Notched Short Bar and Short Rod Specimens Based on Experimental Compliance Measurements, NASA Technical Memorandum 83796, pp. 1-30 (October 1992). Glasses in Table 1 have K_{IC} values greater than 0.9 MPa·m^{1/2}, greater than 0.95 MPa·m^{1/2}, and even greater than 1.00 MPa·m^{1/2} (with low standard deviation for such values, 0.01 MPa·m^{1/2} over 10-11 samples per K_{IC} value), which may be viewed as remarkably high fracture toughness for amorphous glass made by melt-quench methods, as disclosed herein. For example, one might expect soda-lime glass to be 0.7 MPa·m^{1/2}, while Examples A-C had KIC values of 1.03 MPa·m^{1/2}, 1.04 MPa·m^{1/2}, and 1.01 MPa·min, respectively.

Vickers hardness may be measured using ASTM C1326 and C1327 “Standard Test Methods for Vickers Indentation Hardness of Advanced Ceramics,” ASTM International, Conshohocken, PA, US., such as ASTM C1327-15 (2019). Glasses of Table 1 have Vickers hardness values of greater than 750 kgf/mm², 775 kgf/mm², some greater than 800 kgf/mm², and even greater than 825 kgf/mm². Standard deviations for such values were less than 15 775 kgf/mm² over 5 indents. For example, Examples A-C had hardness values of 795 kgf/mm², 838 kgf/mm², and 793 kgf/mm² with standard deviations of 6 kgf/mm², 11 kgf/mm², and 4 kgf/mm², respectively.

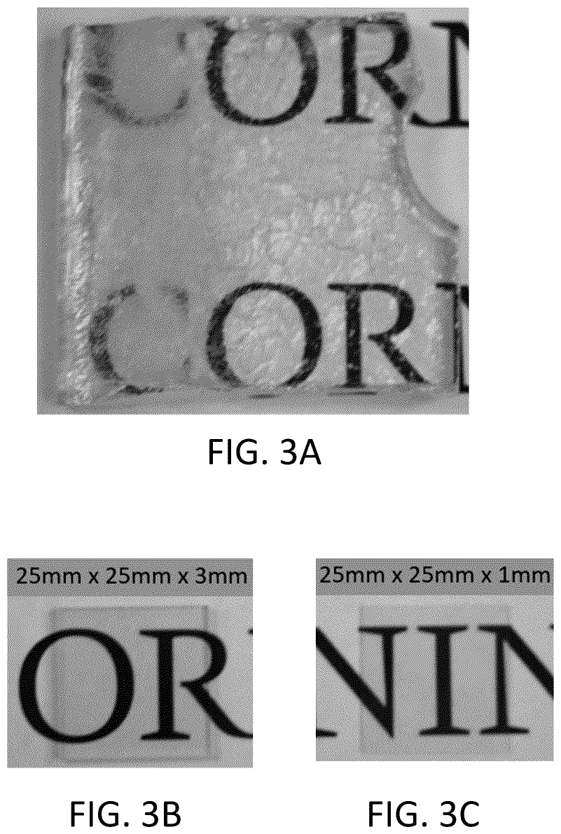

Referring to FIGS. 2A-2C and 3A-3C, a patty of glass of Example G is shown in FIG. 2A, which has been cut into sheets in FIGS. 2B and 2C, and a patty of glass of Example F is shown in FIG. 3A, cut into sheets of FIGS. 3B and 3C for testing and measurements. The sheets are cuboid shaped and were cut from respective patties, thus fit therein, and glasses of the sheets of FIGS. 2B, 2C, 3B, and 3C are amorphous. The sheets of FIGS. 2B and 3B are 25 mm by 25 mm and 3 mm thick, while the sheets of FIGS. 2C and 3C have the same length and width (25 mm) and are 1 mm thick.

Glasses of Table 1 had a refractive index (RI) of greater than 1.5 and less than 2 at 589.3 nm. For example, Examples F and G of FIGS. 3A-3C and 2A-2C had RI values of 1.7554 and 1.7543 respectively at 589.3 nm.

Glasses of Table 1 had a stress optical coefficient (SOC) of greater than 1.25 and less than 1.6. For example, Examples F and G of FIGS. 3A-3C and 2A-2C had SOC values of 1.470 and 1.349 respectively.

According to an aspect and as shown in the Examples, the glasses may be translucent and/or transparent, such as having an average transmittance of at least 10% for light in a wavelength range from 380 nm to 750 nm through a pathlength (e.g., thickness) of a linear dimension (e.g., 0.6 mm, 0.8 mm, 1 mm, 1.4 mm, 2 mm, 3 mm), such as at least 40%, at least 50%, at least 60%, at least 70%, at least 80%, and/or even over 90%. Transmittance in the visible spectrum may be measured with a Lambda 950 UV/Vis/NIR Spectrophotometer manufactured by PerkinElmer Inc. (Waltham, Massachusetts USA). The Lambda 950 apparatus may be fitted with a 150 mm integrating sphere. Data may then be collected using an open beam baseline and a Spectralon® reference reflectance disk. For total transmittance, the sample may be fixed at the integrating sphere entry point. The term “average transmittance,” as used herein with respect to the visible spectrum, refers to the average of total transmittance measurements made within a given wavelength range with each whole numbered wavelengths weighted equally. As used herein, the “average transmittance” with respect to the visible spectrum is over the wavelength range from 380 nm to 750 nm (inclusive of endpoints). Unless otherwise specified, the average transmittance is indicated for light pathlength (e.g., article thickness) of 0.6 mm through glass of the same composition.

The following Table 2 includes similar composition and measurement data for Examples H-P, which may be compared to the Examples of Table 1.

TABLE 2

| | Ex. H | Ex. I | Ex. J | Ex. K | Ex. L | Ex. M | Ex. N | Ex. O | Ex. P |
|---|---|---|---|---|---|---|---|---|---|
| analyzed (mol %) | | | | | | | | | |
| SiO2 | 19.77 | 21.75 | 30.18 | 31.22 | 30.90 | 21.79 | 27.07 | 26.52 | 31.28 |
| Al2O3 | 13.42 | 14.22 | 20.23 | 20.12 | 19.25 | 19.86 | 17.37 | 16.22 | 19.92 |
| B2O3 | 19.58 | 21.00 | 28.61 | 28.72 | 30.47 | 38.80 | 25.12 | 23.69 | 28.76 |
| P2O5 | 0.01 | | 0.01 | 0.01 | | | | | |
| Na2O | 0.88 | 0.01 | 0.17 | 0.05 | 0.06 | | | 0.02 | |
| K2O | 0.02 | | 0.01 | 0.01 | 0.01 | 0.01 | 0.01 | | 0.01 |
| MgO | 0.10 | 0.03 | | 0.05 | 0.01 | 0.04 | 18.78 | 27.82 | 6.75 |
| CaO | 0.14 | 42.96 | 0.18 | 0.02 | 0.03 | 0.03 | 0.15 | 0.21 | 0.07 |
| SrO | 1.10 | 0.01 | 0.01 | 0.07 | | | | | |
| BaO | 44.86 | | | | | | | | |
| Y2O3 | | | | 19.71 | 19.24 | 19.44 | 11.49 | 5.49 | 13.18 |
| La2O3 | | | 20.54 | | | | | | |
| TiO2 | | | 0.03 | 0.01 | | 0.01 | 0.01 | | 0.01 |
| Fe2O3 | 0.01 | | 0.01 | 0.01 | 0.01 | | 0.01 | 0.01 | 0.01 |
| SO3 | 0.10 | | | | | | | | |
| Cl | 0.02 | 0.01 | 0.02 | 0.02 | 0.02 | 0.01 | | 0.01 | 0.01 |
| Properties | | | | | | | | | |
| Density (g/cc) | 3.921 | 2.766 | 3.852 | 3.356 | 3.331 | 3.307 | 3.120 | 2.885 | 3.086 |
| BBV-T_strain (° C.) | 504 | 599 | 649 | 709 | 711 | 689 | 661 | 635 | 674 |
| BBV-T_anneal (° C.) | 536 | 631 | 684 | 745 | 746 | 723 | 697 | 670 | 711 |
| RUS-Young's (GPa) | 69.0 | 91.0 | 102.0 | 113.0 | 113.0 | 112.6 | 110.8 | 108.5 | 107.3 |
| RUS-Shear (GPa) | 27.0 | 35.0 | 40.0 | 44.0 | 44.2 | 44.0 | 43.4 | 42.4 | 42.0 |
| RUS-Poisson's | 0.290 | 0.274 | 0.279 | 0.275 | 0.279 | 0.279 | 0.278 | 0.279 | 0.276 |

As indicated above, alkaline earth metal oxides may increase the elastic modulus and other physical properties of glasses. Example H includes silica, alumina, and boria at mol % amounts as disclosed above and comparable to glasses of Table 1, but Example H is free of yttria and instead includes 44.86 mol % baria (BaO) (e.g., at least 20 mol % and less than 50 mol % thereof), an alkaline earth metal oxide. As shown in the corresponding properties, Example H has a high 3.921 g/cc density, within the range of densities of the Examples of Table 1, but the elastic modulus of Example H is only 69 GPa, higher than other borosilicate glasses but far less than glasses of Table 1 for example.

Similarly, Example I includes silica, alumina, and boria at mol % amounts as disclosed above and comparable to glasses of Table 1, is free of yttria, and instead includes 42.96 mol % quicklime (e.g., at least 20 mol % and less than 50 mol % thereof), another alkaline earth metal oxide. Again, elastic modulus is high, but not near as high as the moduli of glasses in Table 1.

Example J likewise includes silica, alumina, and boria at mol % amounts as disclosed above and comparable to glasses of Table 1, is free of yttria, and includes 20.54 mol % lanthana, a rare earth metal oxide that increases density and stiffness, among other physical properties as shown, relative to borosilicate and soda lime glass, but not as much as glasses of Table 1 with yttria.

Glasses of Examples K, L, and M each primarily include silica, alumina, boria, and yttria, similar to the glasses of Table 1, but the glasses of Examples K, L, and M each have less than 21 mol % of yttria and more than 30 mol % of silica. Resulting physical properties, such as elastic modulus, are high and impressive relative to what one might expect for borosilicate glasses, but still considerably less than those glasses of Table 1 given the general similarity of constituents. For example, the glasses of Examples K, L, and M each have over 14 mol % yttria, and have elastic moduli between 110 GPa and 115 GPa, but not over 120 GPa, 125 GPa, or 130 GPa as shown with examples of Table 1.

Examples N, O, and P of Table 2 are interesting because each includes silica, alumina, and boria in amounts comparable to those of the examples in Table 1, and each includes over 5 mol % of alkaline earth metal oxides, mostly magnesia. The Examples each have fairly high physical properties, such as over 100 GPa elastic moduli, with Example N over 110 GPa, comparable to the moduli of Examples K, L, and M, but with Examples N, 0, and P having less than 14 mol % yttria, but at least 5 mol % yttria. As such, Examples N, 0, and P demonstrate that, when combined with yttria, alkaline earth metal oxides can help maintain greater physical properties of the glasses, such as elastic modulus, in place of some yttria.

In terms of fracture toughness Examples L and N each had fracture toughness values greater than 1.00 MPa·m^{1/2}—Example L with 1.01 MPa·m^{1/2} and standard deviation of 0.01 MPa·m^{1/2} for 10 samples, and Example N with 1.04 MPa·m^{1/2} and standard deviation of 0.06 MPa·m^{1/2} for 2 samples. Example M had fracture toughness of 0.98 MPa·m^{1/2}; and examples O and P had 0.91 MPa·m^{1/2} and 0.99 MPa·m^{1/2}, high fracture toughness values for glasses, but not as tough as those in Table 1. The liquidus temperature of Example L was 1175° C., and Vicker's hardness was 740 kgf/mm² with a 5 kgf/mm² standard deviation over 5 indents.

Referring now to Table 3, roughly 15-gram glass samples corresponding to Examples 1-62 were made and measured (cf. 2000-gram samples of Tables 1-2). Examples 1-62 each contained silica, alumina, boria, and yttria in amounts and ranges as disclosed above, and some of the samples further included lithia or magnesia as shown. As in Tables 1 and 2, density (φ is in g/cc and may be measured as described above. Elastic modulus (E), shear modulus (G), and Poisson's ratio (v) in Table 3 were measured using Brillouin scatter (as opposed to RUS as in Tables 1 and 2) and may include an increased range of error, such as +/−10%. For example, glass of 30 mol % silica, 20 mol % alumina, 30 mol % boria, and 20 mol % yttria was melted three times and measured to have elastic moduli of 117.3 GPa, 118.5 GPa, and 118.2 GPa using Brillouin scatter (also cf. Example L in Table 2, with elastic modulus of 113 GPa). Despite the lesser sample size and precision, Applicants believe data of Table 3 is useful to further demonstrate teachings disclosed herein.

TABLE 3

| | | | | | | | ρ | E | G | |
|---|---|---|---|---|---|---|---|---|---|---|
| (mol %) | SiO₂ | Al₂O₃ | B₂O₃ | Li₂O | MgO | Y₂O₃ | (g/cc) | (GPa) | (GPa) | ν |
| Ex. 1 | 28.59 | 20.00 | 16.41 | | | 35.00 | 4.022 | 144.1 | 55.8 | 0.292 |
| Ex. 2 | 30.00 | 20.00 | 15.00 | | | 35.00 | 4.029 | 143.8 | 55.6 | 0.293 |
| Ex. 3 | 27.53 | 20.00 | 17.47 | | | 35.00 | 3.974 | 142.4 | 55.1 | 0.293 |
| Ex. 4 | 25.00 | 20.00 | 20.00 | | | 35.00 | 3.987 | 140.6 | 54.2 | 0.296 |
| Ex. 5 | 26.47 | 20.00 | 18.53 | | | 35.00 | 3.988 | 140.5 | 54.2 | 0.295 |
| Ex. 6 | 25.00 | 20.00 | 18.62 | | | 36.38 | 4.012 | 139.6 | 54.0 | 0.292 |
| Ex. 7 | 23.62 | 20.00 | 20.00 | | | 36.38 | 4.017 | 139.5 | 54.0 | 0.293 |
| Ex. 8 | 22.50 | 15.00 | 22.50 | | 7.23 | 32.77 | 3.989 | 138.9 | 53.8 | 0.291 |
| Ex. 9 | 25.00 | 20.00 | 20.00 | | | 35.00 | 3.975 | 138.2 | 53.4 | 0.294 |
| Ex. 10 | 22.50 | 15.00 | 22.50 | | 11.69 | 28.31 | 3.864 | 137.2 | 53.2 | 0.289 |
| Ex. 11 | 25.08 | 16.72 | 25.08 | | | 33.12 | 3.895 | 135.4 | 52.5 | 0.291 |
| Ex. 12 | 22.50 | 15.00 | 22.50 | | 15.54 | 24.46 | 3.728 | 134.8 | 52.4 | 0.287 |
| Ex. 13 | 26.88 | 16.88 | 21.88 | 7.93 | | 26.41 | 3.730 | 132.9 | 51.6 | 0.287 |
| Ex. 14 | 24.68 | 16.45 | 24.68 | | 6.29 | 27.90 | 3.777 | 132.7 | 51.4 | 0.292 |
| Ex. 15 | 26.06 | 16.06 | 21.06 | 11.04 | | 25.79 | 3.720 | 132.1 | 51.4 | 0.284 |
| Ex. 16 | 27.75 | 17.75 | 22.75 | 4.67 | | 27.07 | 3.717 | 131.8 | 51.2 | 0.288 |
| Ex. 17 | 26.36 | 16.36 | 21.36 | 10.93 | | 25.00 | 3.683 | 130.9 | 51.0 | 0.284 |
| Ex. 18 | 27.28 | 17.28 | 22.28 | 7.40 | | 25.75 | 3.687 | 130.8 | 50.9 | 0.286 |
| Ex. 19 | 27.40 | 17.40 | 22.40 | 7.80 | | 25.00 | 3.662 | 130.7 | 50.9 | 0.284 |
| Ex. 20 | 24.54 | 16.36 | 24.54 | | 10.39 | 24.18 | 3.632 | 130.7 | 50.8 | 0.287 |
| Ex. 21 | 28.33 | 18.33 | 23.33 | 4.26 | | 25.76 | 3.654 | 130.6 | 50.8 | 0.285 |
| Ex. 22 | 22.50 | 15.00 | 22.50 | | 20.00 | 20.00 | 3.562 | 130.3 | 50.5 | 0.290 |
| Ex. 23 | 29.29 | 19.29 | 24.29 | | | 27.11 | 3.663 | 130.2 | 50.6 | 0.287 |
| Ex. 24 | 25.06 | 20.00 | 24.94 | | | 30.00 | 3.721 | 130.1 | 50.3 | 0.293 |
| Ex. 25 | 25.00 | 15.00 | 20.00 | 15.00 | | 25.00 | 3.711 | 130.0 | 50.6 | 0.284 |
| Ex. 26 | 26.74 | 17.83 | 26.74 | | | 28.70 | 3.703 | 129.7 | 50.3 | 0.290 |
| Ex. 27 | 28.48 | 18.48 | 23.48 | 4.56 | | 25.00 | 3.622 | 129.4 | 50.4 | 0.284 |
| Ex. 28 | 30.00 | 20.00 | 23.20 | | | 26.80 | 3.655 | 128.1 | 49.6 | 0.291 |
| Ex. 29 | 25.57 | 20.00 | 27.43 | | | 26.99 | 3.642 | 128.0 | 49.6 | 0.290 |
| Ex. 30 | 26.16 | 17.44 | 26.16 | | 5.98 | 24.25 | 3.586 | 127.9 | 49.7 | 0.287 |
| Ex. 31 | 29.72 | 19.72 | 24.72 | | | 25.84 | 3.613 | 127.9 | 49.7 | 0.287 |
| Ex. 32 | 27.51 | 20.00 | 25.48 | | | 27.01 | 3.659 | 127.7 | 49.4 | 0.292 |
| Ex. 33 | 24.54 | 16.36 | 24.54 | | 14.57 | 20.00 | 3.496 | 127.0 | 49.3 | 0.288 |
| Ex. 34 | 29.51 | 19.51 | 24.51 | | | 26.47 | 3.618 | 127.0 | 49.2 | 0.290 |
| Ex. 35 | 29.00 | 19.00 | 24.00 | | | 28.00 | 3.676 | 126.8 | 49.1 | 0.292 |
| Ex. 36 | 27.50 | 20.00 | 27.50 | | | 25.00 | 3.567 | 126.5 | 49.1 | 0.288 |
| Ex. 37 | 30.00 | 20.00 | 25.00 | | | 25.00 | 3.574 | 126.5 | 49.1 | 0.288 |
| Ex. 38 | 26.75 | 22.99 | 26.75 | | | 23.51 | 3.514 | 126.4 | 49.1 | 0.287 |
| Ex. 39 | 27.59 | 20.00 | 27.53 | | | 24.88 | 3.558 | 126.3 | 49.0 | 0.288 |
| Ex. 40 | 26.22 | 25.14 | 26.22 | | | 22.43 | 3.475 | 125.8 | 48.9 | 0.287 |
| Ex. 41 | 25.00 | 30.00 | 25.00 | | | 20.00 | 3.387 | 125.8 | 48.9 | 0.287 |
| Ex. 42 | 30.00 | 20.00 | 25.39 | | | 24.61 | 3.543 | 125.4 | 48.7 | 0.288 |
| Ex. 43 | 25.69 | 27.24 | 25.69 | | | 21.38 | 3.418 | 125.2 | 48.6 | 0.289 |
| Ex. 44 | 25.46 | 20.00 | 30.00 | | | 24.54 | 3.550 | 125.2 | 48.5 | 0.290 |
| Ex. 45 | 22.93 | 20.00 | 27.07 | | | 30.00 | 3.732 | 125.2 | 48.4 | 0.294 |
| Ex. 46 | 30.00 | 20.00 | 20.00 | | | 30.00 | 3.736 | 125.0 | 48.2 | 0.296 |
| Ex. 47 | 29.29 | 19.29 | 24.29 | | | 27.12 | 3.663 | 124.9 | 48.3 | 0.292 |
| Ex. 48 | 28.22 | 18.82 | 28.22 | | | 24.73 | 3.527 | 124.9 | 48.6 | 0.286 |
| Ex. 49 | 26.10 | 17.40 | 26.10 | | 10.39 | 20.00 | 3.450 | 124.6 | 48.4 | 0.287 |
| Ex. 50 | 28.03 | 22.67 | 28.03 | | | 21.26 | 3.419 | 124.5 | 48.4 | 0.285 |
| Ex. 51 | 27.18 | 20.00 | 22.82 | | | 30.00 | 3.735 | 124.3 | 48.0 | 0.295 |
| Ex. 52 | 27.00 | 24.74 | 27.00 | | | 21.27 | 3.431 | 124.3 | 48.3 | 0.286 |
| Ex. 53 | 27.51 | 22.71 | 27.51 | | | 22.27 | 3.469 | 124.0 | 48.2 | 0.288 |
| Ex. 54 | 28.26 | 20.00 | 28.26 | | | 23.49 | 3.515 | 123.8 | 48.0 | 0.288 |
| Ex. 55 | 26.45 | 27.09 | 26.45 | | | 20.00 | 3.392 | 123.5 | 47.9 | 0.288 |
| Ex. 56 | 27.52 | 24.96 | 27.52 | | | 20.00 | 3.378 | 122.7 | 47.7 | 0.286 |
| Ex. 57 | 27.49 | 20.00 | 30.00 | | | 22.51 | 3.447 | 122.1 | 47.5 | 0.286 |
| Ex. 58 | 28.80 | 20.00 | 28.80 | | | 22.41 | 3.457 | 121.9 | 47.3 | 0.289 |
| Ex. 59 | 30.00 | 20.00 | 27.44 | | | 22.56 | 3.453 | 121.7 | 47.3 | 0.287 |
| Ex. 60 | 27.72 | 18.48 | 27.72 | | 6.07 | 20.00 | 3.401 | 121.4 | 47.2 | 0.285 |
| Ex. 61 | 28.58 | 22.84 | 28.58 | | | 20.00 | 3.364 | 120.7 | 47.0 | 0.284 |
| Ex. 62 | 29.32 | 20.00 | 29.32 | | | 21.36 | 3.407 | 120.6 | 46.9 | 0.285 |

Notably the glasses of Table 3 each comprise silica, alumina, boria, and yttria as disclosed above and each has an elastic modulus greater than 120 GPa. Table 3 is arranged in order or highest to lowest elastic-modulus glasses, with all elastic moduli greater than 120 GPa. The highest elastic modulus glasses generally had more yttria than the lesser modulus glasses and also generally had less silica or less boria in exchange for the greater amount of yttria and/or more alumina (see, e.g., Examples 1-5, which each were measured to have elastic moduli greater than 140 GPa!). With that said, Example 6-7 evidence that further increasing yttria over 35 mol % may decrease the elastic modulus for at least some such glasses.

Glasses in Table 3, such as Examples 8, 10, 12, 14, 20, and 22 for example, demonstrate that inclusion of considerable amounts of alkaline earth metal oxides, here magnesia over 5 mol % and within ranges disclosed above, did not greatly undermine physical properties of the respective glasses—each such glasses were measured to have elastic moduli over 130 GPa. Similarly, glasses in Table 3, such as Examples 13, 15-19, 21, and 25 for example, likewise demonstrate that inclusion of considerable amounts of alkali metal oxides, here lithia over 5 mol % and within ranges disclosed above, did not greatly undermine physical properties of the respective glasses—each such glass were also measured to have elastic moduli over 130 GPa. Inclusion of lithia (or sodium oxide for example) may allow the glasses to be strengthened via chemical tempering by soaking in a molten salt bath of salts comprising larger alkali metal ions, such as potassium nitrate and/or potassium sulfate.

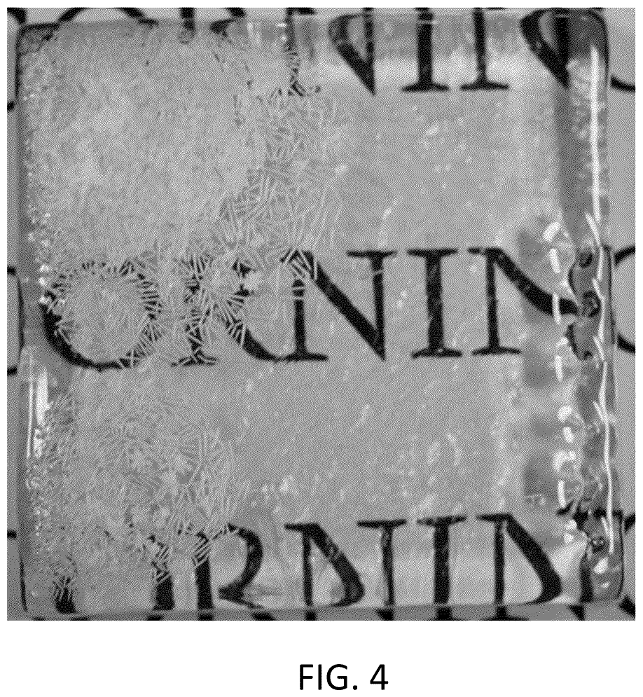

Applicants have recently begun 2000-g melts of lithium-containing glasses similar to those just described in Table 3, such as the glass shown in FIG. 4, which comprises 27.4 mol % silica, 17.4 mol % of alumina, also 17.4 mol % of boria, 30 mol % yttria, and 8.8 mol % lithia. Notably, the glass in FIG. 4 includes some surface crystallization as shown on the left side of the sample. The crystals do not extend deeply into the sample and smaller pieces will be cut from this sample, similar to those shown in FIGS. 2B-2C and 3B-3C, for further experimentation and measurements, such as strengthening via chemical tempering.

As such, according to an aspect, Applicants contemplate the glasses may be ion-exchanged to have a surface or peak compressive stress (e.g., at least 50 MPa, at least 100 MPa) and central tension (e.g., at least 10 MPa) in a salt bath comprising a molten mixture of sodium nitrate, sodium sulfate, potassium nitrate, and/or potassium sulfate salts at a temperature exceeding 500° C. In the salt bath, wt % of sodium nitrate may be greater than sodium sulfate, wt % of potassium nitrate may be greater than potassium sulfate, and/or wt % of sodium-containing salts may be greater than potassium-containing salts. Hotter salt baths may increase the depth of compression (e.g., at least 5 μm, at least 10 μm, at least 30 μm), where compressive stress transitions to tensile within an article of the glass, may shorten an amount of time for soaking the glass in such baths, and may increase surface or peak compressive stress compared to chemical tempering in salt baths at temperatures under 400° C. and baths of all nitrate salts for example. Applicants hereby incorporate by reference herein in its entirety U.S. Application No. 63/600,790 filed Nov. 20, 2023.

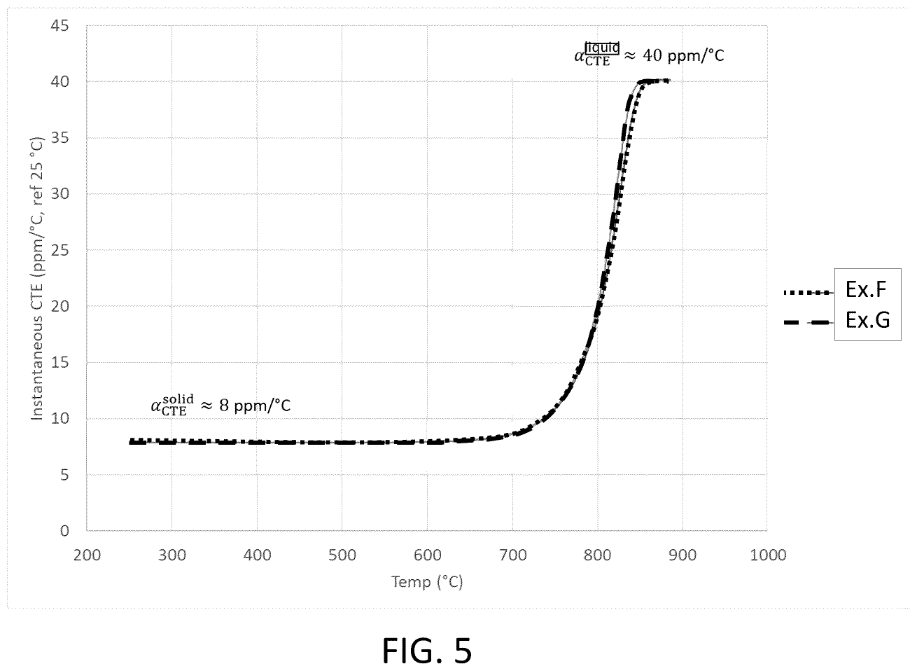

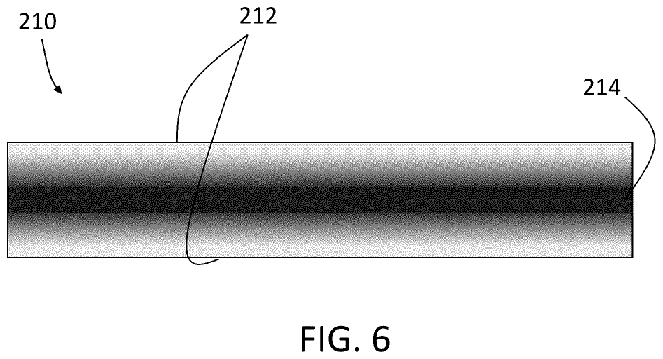

Referring now to FIG. 5, coefficient of thermal expansion (“CTE”; y-axis) for the glasses of Examples F and G in Table 1 and shown in FIGS. 2A-2C and 3A-3C are plotted as a function of temperature (x-axis). At lower temperatures, the CTE is fairly low, 8 ppm/° C. This is less than a CTE one might expect for soda lime glass, which may be around 9 ppm/° C. However, while glasses typically have increased CTEs at high temperatures (e.g., maybe twice the low-temperature CTE), as shown in the plot of FIG. 5, glasses of Table 1 have high-temperature CTEs (e.g., at 875° C.) over 35 ppm/° C., around 40 ppm/° C., which is surprisingly high compared to the lower temperature CTEs.

Applicants believe that the combination of high elastic moduli and the high high-temperature CTE of glasses disclosed herein make the glasses highly-suitable for thermal tempering. To temper the glasses in this manner, Applicants heat an article 210 comprising the glasses (e.g., sheet, tube, vial, rod) over 700° C., such as over 800° C., such as over 850° C., such as to a glass transition temperature thereof, such that the glass is in a state of expanded molecular network. Then Applicants rapidly cool the article 210 from surfaces 212 thereof inward. Glass at the surfaces 212 is ‘frozen’ at a higher fictive temperature than glasses interior 214 to the surfaces 212, corresponding to a more expanded network. Interior to the surfaces 212, the glass of the article cools more slowly and condenses to a greater degree, draw the surfaces 212 into compression. According to an aspect, the article is thermally tempered such that surfaces thereof experience a compressive stress of at least 10 MPa, at least 50 MPa, at least 100 MPa, such as at least 200 MPa, such as at least 300 MPa, and/or no more than a frangibility limit of the glasses, and/or no more than 5 GPa for example.

Construction and arrangements of the compositions, assemblies, and structures, as shown in the various aspects, are illustrative only. Although only a few examples of the aspects have been described in detail in this disclosure, modifications are possible (e.g., variations in sizes, dimensions, structures, shapes, and proportions of the various elements, values of parameters, mounting arrangements, use of materials, colors, orientations) without materially departing from the novel teachings and advantages of the subject matter described herein. For example, while being translucent and/or transparent as disclosed above, the glass and corresponding articles may be colored, and U.S. Application No. 63/537,466 filed Sep. 8, 2023 is incorporated by reference herein in its entirety. The order or sequence of any process, logical algorithm, or method steps may be varied or re-sequenced according to alternative embodiments. Other substitutions, modifications, changes and omissions may also be made in the design, operating conditions and arrangement of the various aspects without departing from the scope of the present inventive technology.

1. A glass, in mole percent (mol %) of representative oxides, comprising:
silica in an amount greater than 12 mol % and less than 45 mol %;
alumina in an amount greater than 12 mol % and less than 45 mol %;
boria in an amount greater than 8 mol % and less than 45 mol %;
yttria in an amount greater than 21 mol % and less than 45 mol %.

2-9. (canceled)

10. (canceled)

11. The glass of claim 1, wherein the yttria is greater than 24 mol %.

12. The glass of claim 1, wherein the boria is greater than 12 mol %.

13. The glass of claim 1, wherein the silica is less than 28 mol %.

14. The glass of claim 1, further comprising lithia in an amount greater than 5 mol % and less than 30 mol %.

15. The glass of claim 1, further comprising magnesia in an amount greater than 5 mol % and less than 30 mol %.

16. A glass article, comprising:
a body of the glass of claim 1,
wherein the body has a geometry overlaying a cuboid space with volume greater than 100 mm³ and less than 275 dam³, wherein the cuboid space is free of crystals;
wherein the body comprises opposing surfaces and a center therebetween; and
wherein the surfaces are under compressive stress offset by tension in the center, wherein the compressive stress is at least 100 MPa.

17. (canceled)

18. The article of claim 16 wherein fictive temperature of the glass at the surfaces is greater than that of the glass at the center.

19. A glass article, comprising:
a body of the glass of claim 1,
wherein the body comprises opposing surfaces and a center therebetween;
wherein the surfaces are under compressive stress offset by tension in the center, wherein the compressive stress is at least 100 MPa.

20. The article of claim 19 wherein fictive temperature of the glass at the surfaces is greater than that of the glass at the center.
